(19) United States
(12) Patent Application Publication
(10) Pub. No.: US 2026/0303556 A1
(43) Pub. Date: Oct. 1, 2026

(54) VALIDATING PREDICATE-BASED FILTERS USED IN ASYNCHRONOUS MESSAGING SYSTEMS

(71) Applicants: Oracle International Corporation, Redwood Shores, CA (US); Indian Institute of Technology Roorkee, Roorkee (IN)

(72) Inventors: Manish Kumar Agrawal, Bangalore (IN); Ashok Shukla, Fremont, CA (US); Sandeep Kumar, Roorkee (IN); Yogesh Kumar, Saratoga, CA (US)

(21) Appl. No.: 19/090,493

(22) Filed: Mar. 26, 2025

(51) Int. Cl. H04L 51/212; G06F 40/226; H04L 1/08

(52) U.S. Cl. CPC H04L 51/212; G06F 40/226; H04L 1/08

(57) ABSTRACT

An aspect of the present disclosure facilitates validating predicate-based filters used in asynchronous messaging systems. In one embodiment, a digital processing system identifies a predicate-based filter sought to be validated, and parses the predicate-based filter to determine a set of element identifiers contained in the predicate-based filter. The system generates a payload with each of the set of element identifiers assigned to a corresponding value and executes the predicate-based filter against the payload. The system indicates that the predicate-based filter is valid if a status of executing is a success, and is invalid otherwise.

### BACKGROUND OF THE DISCLOSURE

### Technical Field

The present disclosure relates to enterprise computing and more specifically to validating predicate-based filters used in asynchronous messaging systems.

### Related Art

Asynchronous messaging systems (ASMs) are commonly used for dissemination of information among a large number of varied computing systems. Typically, computing systems (referred to as “producers”) generate messages/events indicating their various internal states/statuses of interest to other computing systems. Other computing systems (referred to as “consumers”) may thereafter receive and process these messages/events, with processing entailing performing any desired actions. In the following disclosure, the terms “message” and “event” are used interchangeably to refer to any data generated by a computing system to indicate its internal state/status.

The term “asynchronous” implies that the communications of the messages/events between the producers and the consumers is performed independent of the availability of the generating producer and processing consumer. ASM acts as a broker between the producers and consumers, specifically to receive the generated messages from the producers and then forwarding the messages to the appropriate consumers (when available).

Predicate-based filters are commonly used by consumers to screen/select the messages to be received from ASM. A predicate-based filter typically specifies one or more conditions based on the content of the message or metadata (such as tags) associated with the message, with the conditions together returning a Boolean value (true or false) as a result of applying the filter. ASM, upon receiving a message generated by a producer, applies the predicate-based filter specified by a consumer against the content/metadata of the message, and then forwards the message to the consumer only if the result of the applying of the filter is true (that is the content/metadata of the message satisfies the conditions specified in the filter). The message is not forwarded (that is discarded as per the view of the consumer) if the result is false.

By using appropriate predicate-based filters, a consumer is enabled to screen the messages generated by different producers and receive only the messages of interest to itself. However, it may be appreciated that any syntactical or semantic mistake in a predicate-based filter may cause a message of interest to be wrongly discarded by the ASM. Such discarded/lost messages might result in substantive loss for the consumer.

Accordingly, it may be desirable that predicate-based filters be validated (checked for syntactic and semantic accuracy) prior to deployment in ASMs. Such validation may need to be performed at the design phase, for example, when a subscriber subscribes to a class in the pub-sub model. Aspects of the present disclosure are directed to validating predicate-based filters used in asynchronous messaging systems.

### BRIEF DESCRIPTION OF THE DRAWINGS

Example embodiments of the present disclosure will be described with reference to the accompanying drawings briefly described below.

FIG. 1 is a block diagram illustrating an example computing environment in which several aspects of the present disclosure can be implemented.

FIG. 2A is a block diagram illustrating the manner in which a publisher-subscriber (pub-sub) is implemented in one embodiment.

FIG. 2B illustrates the manner in which messages/events are received by a pub-sub system handling a healthcare scenario in one embodiment.

FIG. 2C depicts sample predicate-based filters specified as part of subscription requests in one embodiment.

FIG. 2D illustrates the manner in which a message is processed by a pub-sub system in one embodiment.

FIG. 3 is a flow chart illustrating the manner in which predicate-based filters used in asynchronous messaging systems are validated according to aspects of the present disclosure.

FIG. 4 is a block diagram illustrating an implementation of a validation tool in one embodiment.

FIG. 5A depicts portions of a subscription request received by a pub-sub system in one embodiment.

FIG. 5B depicts portions of a grammar that can be used for parsing predicated-based filters in one embodiment.

FIG. 5C depicts portions of a filter tree generated corresponding to a predicate-based filter in one embodiment

FIG. 5D depicts sample payloads that are dynamically generated for validating a predicate-based filter in one embodiment.

FIG. 5E depicts the texts of recoverable faults caused during execution of a predicate-based validator against dynamically generated payloads in one embodiment.

FIG. 6 is a flow chart illustrating the manner in which sub-predicates of a predicate-based filter are validated according to aspects of the present disclosure.

FIGS. 7A-7B together depicts a set of procedures used to validate a predicate-based filter in one embodiment.

FIG. 8 is a block diagram illustrating the details of a digital processing system in which various aspects of the present disclosure are operative by execution of appropriate executable modules.

In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE EMBODIMENTS OF THE DISCLOSURE

### 1. Overview

An aspect of the present disclosure provides a technical tool that validates predicate-based filters used for filtering/selecting events. In one embodiment, a digital processing system identifies a predicate-based filter sought to be validated, and parses the predicate-based filter to determine a set of element identifiers contained in the predicate-based filter. The system generates a payload with each of the set of element identifiers assigned to a corresponding value and executes the predicate-based filter against the payload. The system indicates that the predicate-based filter is valid if a status of executing is a success, and is invalid otherwise.

Such validation may be performed prior to deployment of the filter for selection of events to prevent false negatives, i.e., avoiding missing of legitimate events, which ought to be selected by the filter. The increased accuracy that can be expected from such validated predicate-based filters is of particular benefit in various technical environments such as asynchronous messaging systems.

According to another aspect of the present disclosure, upon receiving, at a pub-sub system (example of an asynchronous messaging system), a subscription request containing the predicate-based filter, the system extracts the predicate-based filter from the subscription request. A new subscription based on the subscription request is created, in the pub-sub system, if the system indicates that the predicate-based filter is valid. The subscription request is rejected if the system indicates that the predicate-based filter is invalid.

According to one more aspect of the present disclosure, the system determines whether executing (predicate-based filter against the payload) of the payload causes a fault and sets the status to success if the system determines that no the fault is caused by executing.

According to yet another aspect of the present disclosure, the fault (noted above) is a Run time Exception. When the executing causes the fault, the system checks whether the fault is a recoverable fault or a non-recoverable fault. If the fault is recoverable fault, the system forms a new payload with at least one element identifier of the set of element identifiers assigned to a new value and performs the executing, the determining and the setting for the predicate-based filter against the new payload. If the fault is non-recoverable fault, the system sets the status to a failure.

According to an aspect of the present disclosure, the recoverable fault is a mismatch in data type for a first element identifier in the set of element identifiers. For forming, the system analyzes a text of the recoverable fault to determine that the first element identifier is of a first data type and updates the first element identifier in the payload to the new value of the first data type to form the new payload.

According to another aspect of the present disclosure, the system finds a set of sub-predicates contained in the predicate-based filter, and performs executing and determining (both noted above) for each sub-predicate of the set of sub-predicates against the payload. The system sets the status to success if the system determines that no the fault is caused by the executing of all of the set of sub-predicates, and sets the status to failure if non-recoverable fault is caused by the executing of any of the set of sub-predicates.

According to one more aspect of the present disclosure, for parsing (noted above), the system provides to a parser generator, a grammar and the predicate-based filter as inputs and obtains a filter tree as output, the filter tree representing an abstract syntax tree corresponding to the predicate-based filter. The filter tree is used to determine the set of element identifiers and find the set of sub-predicates.

According to yet another aspect of the present disclosure, the filter tree contains multiple nodes including a root node and terminal nodes. For executing (noted above), the system evaluates the filter tree starting from the root node. The evaluating of a node includes if the node is a binary node: evaluating a left subtree of the node against the payload to return a left result; evaluating a right subtree of the node against the payload to return a right result; and if the left result and the right result are both success, returning a success if a binary operation associated with the node executes successfully against the payload or a failure otherwise. If the node is a terminal node, returning a success if a condition associated with the node holds against the payload or a failure otherwise.

Thus, aspects of the present disclosure are directed to a dynamic filter validation process that combines recursive parsing with dynamic payload generation to evaluate complex filter expressions efficiently. Using a tree-based approach allows the system to handle binary and terminal nodes effectively, breaking down expressions and validating them in atomic steps.

Several aspects of the present disclosure are described below with reference to examples for illustration. However, one skilled in the relevant art will recognize that the disclosure can be practiced without one or more of the specific details or with other methods, components, materials and so forth. In other instances, well-known structures, materials, or operations are not shown in detail to avoid obscuring the features of the disclosure. Furthermore, the features/aspects described can be practiced in various combinations, though only some of the combinations are described herein for conciseness.

### 2. Example Environment

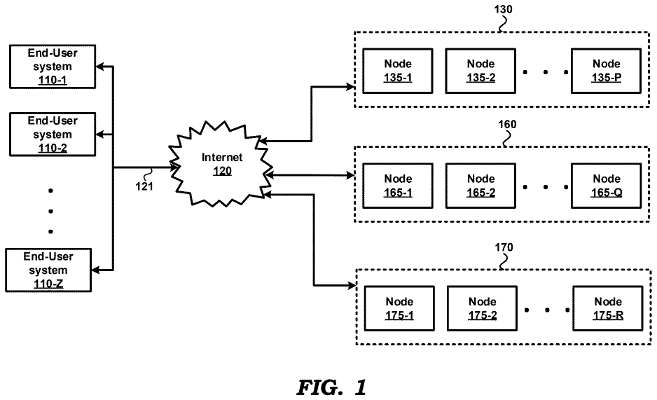

FIG. 1 is a block diagram illustrating an example computing environment in which several aspects of the present disclosure can be implemented. The block diagram is shown containing end-user systems 110-1 through 110-Z (Z representing any natural number), Internet 120, and computing infrastructures 130, 160 and 170. Computing infrastructure 130 in turn is shown containing nodes 135-1 through 135-P (P representing any natural number). Computing infrastructure 160 in turn is shown containing nodes 165-1 through 165-Q (Q representing any natural number). Computing infrastructure 170 in turn is shown containing nodes 175-1 through 175-R (R representing any natural number). The end-user systems and nodes are collectively referred to as 110, 135, 165 and 175 respectively.

Merely for illustration, only representative number/type of systems are shown in FIG. 1. Many environments often contain many more systems, both in number and type, depending on the purpose for which the environment is designed. Each block of FIG. 1 is described below in further detail.

Each of computing infrastructures 130, 160 and 170 is a collection of physical processing nodes (135, 165 and 175), connectivity infrastructure, data storages, administration systems, etc., which are engineered to together host application/data services. For illustration, the aspects of the present disclosure are described below with respect to application services, though the same aspects can be applied to data services as well as will be apparent to one skilled in the relevant arts by reading the disclosure herein.

Computing infrastructure 130/160/170 may be a cloud infrastructure such as Amazon Web Services (AWS) available from Amazon.com, Inc., Azure available from Microsoft Corporation, Google Cloud Platform (GCP) available from Google LLC, Oracle Cloud Infrastructure (OCI) available from Oracle Corporation, etc. that provides a virtual computing infrastructure for various customers/tenants, with the scale of such computing infrastructure being specified often on demand. Alternatively, computing infrastructures 130/160/170 may also correspond to an enterprise system (or a part thereof) on the premises of the customers (and accordingly referred to as “On-prem” infrastructure). Computing infrastructures 130/160/170 may also be a “hybrid” infrastructure containing some nodes of a cloud infrastructure and other nodes of an on-prem enterprise system.

All the systems of each computing infrastructures 130/160/170 are assumed to be connected via a corresponding intranet (not shown). Internet 120 extends the connectivity of these (and other systems of the computing infrastructures) with external systems such as end-user systems 110. Each of the intranets (not shown) and Internet 120 may be implemented using protocols such as Transmission Control Protocol (TCP) and/or Internet Protocol (IP), well known in the relevant arts.

In general, in TCP/IP environments, a TCP/IP packet is used as a basic unit of transport, with the source address being set to the TCP/IP address assigned to the source system from which the packet originates and the destination address set to the TCP/IP address of the target system to which the packet is to be eventually delivered. An IP packet is said to be directed to a target system when the destination IP address of the packet is set to the IP address of the target system, such that the packet is eventually delivered to the target system by Internet 120 and respective intranet. When the packet contains content such as port numbers, which specifies a target application, the packet may be said to be directed to such application as well.

Each of end-user system 110 represents a system such as a personal computer, workstation, mobile device, computing tablet, etc., used by users to generate (user) requests directed to application services executing in computing infrastructures 130/160/170. A user request refers to a specific technical request (for example, Universal Resource Locator (URL) call) sent to a server system from an external system (here, end-user system) over Internet 120, typically in response to a user interaction at end-user systems 110. The user requests may be generated by users using appropriate user interfaces (e.g., web pages provided by an application executing in a node, a native user interface provided by a portion of an application downloaded from a node, etc.).

In general, an end-user system 110 requests an application service for performing desired tasks and receives the corresponding responses (e.g., web pages) containing the results of performance of the requested tasks. The web pages/responses may then be presented to a user by a client application such as the browser. Each user request is sent in the form of an IP packet directed to the desired system or application service, with the IP packet including data identifying the desired tasks in the payload portion.

Some of nodes 135/165/175 may be implemented as corresponding data stores. Each data store represents a non-volatile (persistent) storage facilitating storage and retrieval of data by application services executing in the other systems/nodes of computing infrastructures 130/160/170. Each data store may be implemented as a corresponding database server using relational database technologies and accordingly provide storage and retrieval of data using structured queries such as SQL (Structured Query Language). Alternatively, each data store may be implemented as a corresponding file server providing storage and retrieval of data in the form of files organized as one or more directories, as is well known in the relevant arts.

Some of the nodes 135/165/175 may be implemented as corresponding server systems. Each server system represents a server, such as a web/application server, constituted of appropriate hardware, executing application/data services capable of performing one or more tasks. The tasks may be specified as part of user requests received from end-user systems 110 or node requests received from nodes of same/other cloud infrastructures.

A node/server system, in general, receives a task request (user request or node request) and performs the tasks requested in the task request. A server system may use data stored internally (for example, in a non-volatile storage/hard disk within the server system), external data (e.g., maintained in a data store) and/or data received from external sources (e.g., received from a user) in performing the requested tasks. The server system then sends the result of performance of the tasks to the requesting system (end-user system 110 or node 135/165/175) as a corresponding response to the task request. The results may be accompanied by specific user interfaces (e.g., web pages) for displaying the results to a requesting user.

In one embodiment, application/data services executing in nodes 135/165/175 are designed to communicate among themselves via messages/events. Specifically, some of the application/data services operate as producers that generate messages, with other services operating as consumers consuming (receiving and processing) the messages. An asynchronous messaging system (implemented on one/few of nodes 135/165/175) operates as a broker (receiving and forwarding the messages) between the producers and the consumers.

In one embodiment, the asynchronous messaging system is a publisher-subscriber (pub-sub) model where publishers/producers are required to generate messages categorized into one or more pre-specified classes and subscribers/consumers independently express interest in (“subscribe to”) one or more classes of their choice. When messages are generated by publishers, the asynchronous messaging system determines the classes of the generated messages and forwards the messages to the subscribers subscribed to the determined classes. An example publisher-subscriber system is described below with examples.

### 3. Publisher-Subscriber (Pub-Sub) System

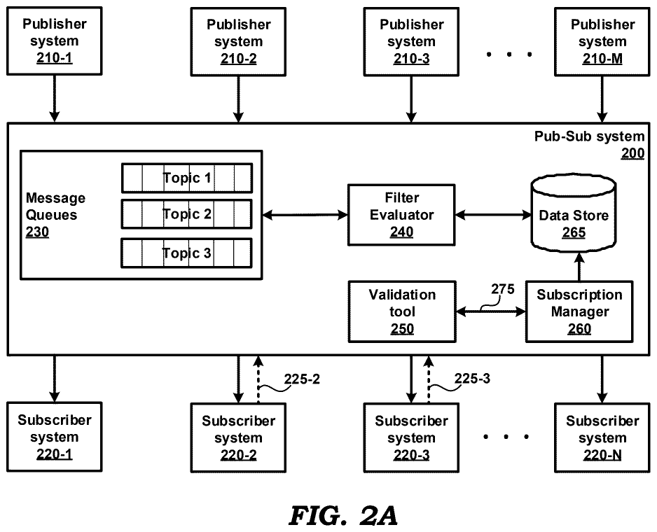

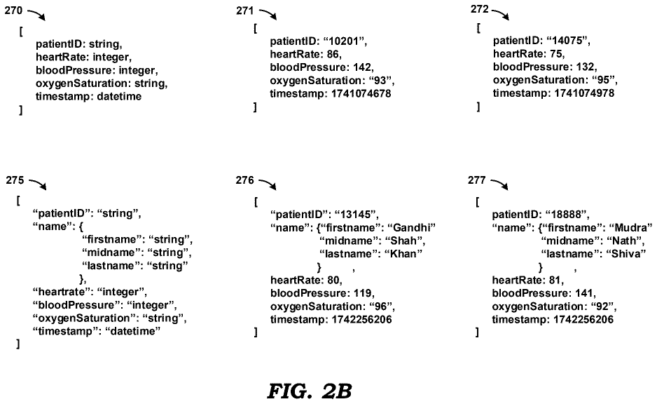

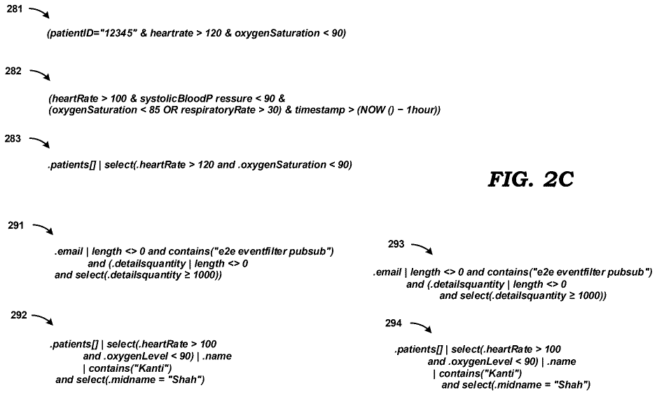

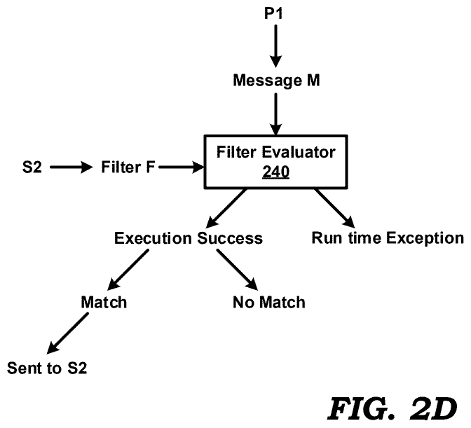

FIG. 2A is a block diagram illustrating the manner in which a publisher-subscriber (pub-sub) is implemented in one embodiment. The block diagram is shown containing pub-sub system 200 (in turn shown containing message queues 230, filter evaluator 240, validation tool 250, subscription manager 260 and data store 265), publisher systems 210-1 to 210-M (M representing any natural number) and subscriber systems 220-1 to 220-N (N representing any natural number). The publisher systems and the subscriber systems are collectively referred to as 210 and 220 respectively. Each block of the Figure is described below in further detail.

Each of publisher systems 210 and subscriber systems 220 represents various nodes (135/165/175) of computing infrastructures 130/160/170 with application/data services deployed therein (referred to as publishers/subscribers). Publisher systems 210 are designed to generate messages/events, while subscriber systems 220 are designed to consume one of more of the generated messages/events. Pub-sub system 200, implemented on one/few of nodes 135/165/175, operates as a broker (receiving and forwarding the messages) between publisher systems 210 and subscriber systems 220. Examples of such a pub-sub system is Google Pub/Sub available from Google Corporation and Oracle Pub/Sub available from Oracle International Corporation.

According to the pub-sub model, a subscriber system (assumed to be 220-2 for illustration) wishing to consume (receive and process) messages of a desired type, sends a subscription request 225-2 to (subscription manager 260 of) pub-sub system 200. The subscription request typically includes a class (assumed to be Topic 1) of messages and a predicate-based filter designed to select only the messages of the desired type from the class. It may be noted that such selection may be needed since pub-sub system 200 may receive a large number of messages in the same class itself.

Subscription manager 260 receives subscription requests (such as 225-2) from various subscriber systems 210 and stores the information (class and any predicate-based filter) specified in the received requests in data store 265. Data store 265 represents a non-volatile (persistent) storage facilitating storage and retrieval of data by other components of pub-sub system 200. Data store 265 may be implemented as a database server or a file server as described above. The description in continued assuming that data store 265 has currently stored data indicating the details of subscription request 225-2.

Pub-sub system 200 starts receiving messages generated by publisher systems 210, categorizes them into different classes (Topic 1, Topic 2, Topic 3, etc.) and stores the received messages in corresponding message queues 230. Message queues 230 represents a volatile storage (such as a random access memory (RAM)) that stores messages according to their classes in various queues (with each queue typically being sorted based on receiving time of the messages). It should be noted that incoming messages are merely temporarily buffered in the RAM, and are typically not stored in non-volatile storages due to reasons such as the large number of messages received, the high frequency at which the messages are received, there being no need to retain the messages once they are forwarded, etc.

Filter evaluator 240 is designed to distribute the buffered messages to subscriber systems 220. In particular, filter evaluator 240 retrieves a message from a queue (corresponding to a class, such as Topic 1) and determines (based on the data in data store 265) a set of subscriber systems 220 that have subscribed to the class (Topic 1). For each subscriber system of the determined set, filter evaluator 240 then checks whether any predicate-based filter has been specified by the subscriber system. If no such filter is present, filter evaluator 240 merely forwards the retrieved message to the subscriber system.

If a filter is present, filter evaluator 240 applies the specified filter to the content/metadata of the retrieved message. Filter evaluator 240 forwards the retrieved message to the subscriber system only if the result of the applying the filter is true (that is the content/metadata of the message satisfies the conditions specified in the filter), and does not forward the message if the result is false. Filter evaluator 240 performs the above processing for each message in each of message queues 230, and as such may be implemented as multi-threaded for efficient execution.

Thus, pub-sub system 200 operates to broker the messages between publisher systems 210 and subscriber systems 220. For better understanding, the operation of pub-sub system 200 in an example scenario is described below with examples.

### 4. Pub-Sub System Operation in an Example Scenario

The description in continued assuming that the environment of FIG. 2A is designed to handle messages in a Healthcare scenario. Each of publisher systems 210 may correspond to a health care entity such as a hospital, clinic, diagnostic center, etc. or a medical device such as a wearable smart watch, medical monitoring devices, etc., that are designed to generate messages related to the health status of a patient. Subscriber systems 220 may correspond to (personal) devices used by the patients, the caretakers associated with the patients, doctors, medical staff, etc.

FIG. 2B illustrates the manner in which messages/events are received by a pub-sub system (200) handling a healthcare scenario in one embodiment. Data portion 270 illustrates a schema/format of messages received in the healthcare scenario. Specifically, data portion 270 indicates the health status of a patient and is shown containing four elements/fields (separated by comma) with each field having a respective name/identifier (e.g., patientID, heartRate, etc.) and a respective data type (e.g., string, Integer, etc.) The schema indicates the format in which the messages are received from publisher systems 210.

Data portions 271 and 272 depict sample messages that may be received from publisher systems 210 according to the schema of data portion 210. The messages are shown generated according to JSON (JavaScript Object Notation) in one embodiment, and specifies a respective value associated with each of the element identifiers (with the value being of the data type specified in the schema). It should be noted that data portions 271 and 272 depict only the payload of the messages. The messages may have additional information (used for routing, encryption, error checking, etc.) that is not shown here for conciseness.

Data portion 275 illustrates another schema/format of messages received in the healthcare scenario. It may be observed that in addition to the elements of data portion 270, an additional element “name” is shown containing sub-elements (such as “firstname”, “midname”, etc.). Such sub-elements which are within other elements are referred to as nested elements, as is well known in the relevant arts. Date portions 276 and 277 depict sample messages that may be received from publisher systems 210 according to the schema of data portion 275.

It may be appreciated that the message schema of data portion 270/275 defines an information space (class) in healthcare. Multiple information spaces may be similarly specified, where each information space is linked to a message/event schema that specifies the structure and type of data contained within each message/event. Some other information spaces in the healthcare scenario may be Lab Results Information Space [patientID: string, testType: string, testResult: string, resultRange: string, timestamp: datetime], Medication Information Space: [patientID: string, medicationID: string, dosage: string, frequency: string, timestamp: datetime] and Diagnosis Information Space: [patientID: string, diagnosisCode: string, severity: string, physicianID: string, timestamp: datetime].

Such information spaces may be required to be filtered to obtain only the messages of interest to subscriber systems 220. The manner in which predicate-based filters may be specified (as part of subscription requests) to filter the messages is described below with examples.

FIG. 2C depicts sample predicate-based filters specified as part of subscription requests in one embodiment. Data portion 280 specifies an example predicate-based filter that may be received as part of a subscription request (such as 225-2). Specifically, data portion 280 indicates that the subscriber system (220-3) would only receive messages where the patientId is “12345”, the heart rate is greater than 120, and the Oxygen saturation is less than 90. It may be observed that the conditions are specified based on the field/element identifiers specified in the message schema of data portion 270/275.

In general, filters for subscription requests can be specified based on key-value pairs that describe specific attributes/elements of an event or message (such as ‘tradeQuantity,500’ for receiving messages where the trade quantity is 500, ‘name, Acme’ for receiving messages involving the entity ‘Acme’). The filter can also involve predicates, allowing for more complex filtering logic such as “name==‘Acme’ and tradeQuantity>500” for receiving messages where the entity is ‘Acme’ and the trade quantity is greater than 500. Conjunctions (AND) and disjunctions (OR) can be applied between multiple predicates, allowing subscribers to fine-tune the criteria that dictate which messages they receive. Another method of subscription filtering involves tags or keywords (metadata). For example: A user could subscribe to messages tagged with “finance” or “tech”, enabling them to receive messages that match those specific categories, regardless of the precise event content.

More complex filters may be specified, for example using XPATH (XML Path Language) expressions, or having complex sub-predicates combining multiple medical parameters, historical data, and even temporal conditions. For example, for a scenario where a hospital wants to monitor patients who are at high risk of heart failure, a complex predicate (included in a subscription request) is shown in data portion 281. The predicate-based filter of data portion 281 would trigger an alert when the patient's heart rate is elevated, blood pressure is critically low, and either their oxygen saturation is dangerously low or their respiratory rate is abnormally high. The condition also ensures that only recent data (within the last hour) is considered, filtering out outdated information.

In one embodiment, the predicate-based filters are specified according to JQ (JSON query) syntax to extract specific information from JSON messages received from publisher systems 210. Data portion 282 depicts a filter specified using JQ (corresponding to the filter shown in data portion 280). The description is continued with the manner in which messages are processed based on predicate-based filters.

FIG. 2D illustrates the manner in which a message is processed by a pub-sub system in one embodiment. Specifically, the Figure illustrates the manner in which a message M is processed by filter evaluator 240 of pub-sub system 200. Message M represents one of data portions 271, 272, 276 and 277 that has been generated for a class (Topic 1) by publisher system P1 (one of 210), while subscriber system S2 (one of 220) has subscribed to the same class while also specifying a filter F (such as that shown in data portion 281). As such, filter evaluator 240 applies filter F against message M. Applying the filter may require executing filter F against the payload of message M, which may cause two results—(1) Execution Success wherein the conditions specified in filter F is able to be checked against the payload of message M to determine whether the condition is satisfied (Match) or not satisfied (No Match) and (2) Run time Exception typically thrown due to syntactic/semantic errors in the conditions specified in filter F. Message M is forwarded to S2 only on Match, and not sent (discarded as per S2) in both No Match and Run time Exception scenarios. It may be noted that subscriber S2 does not have visibility into the specific reason for non-receipt of a message.

In some domains such as healthcare or financial trading, subscriptions often require complex predicate-based filters (that may include nested elements) to ensure that only relevant events are delivered to subscribers. These filters are written by non-technical users such as doctors, lab assistants, or trade analysts. However, crafting these filters is not always straightforward, and there is significant room for human error. Even a small syntax mistake or incorrect logic in the predicate logic could result in missed events, including legitimate ones that meet the intended criteria.

Referring again to FIG. 2C, data portion 291 depicts an invalid predicate-based filter that may be specified as part of a subscription request. Here, ‘contains’ and ‘select’ both are contradictory, since the ‘contains’ operator expect inputs of string datatype, while the ‘select’ operator expects inputs of element datatype. Such a filter passes compile and execution test with empty payload. However, the filter of data portion 291 will definitely fail (cause Run time Exception) at runtime with actual payload. Data portion 292 depicts another such invalid predicate-based filter that may cause messages to be not sent to the subscribers.

Data portions 293 and 294 depict invalid predicate-based filters that may be specified for schemas with nested elements. It may be appreciated that in data portion 293, the ‘contains’ expression treats the “.email” as a string, but the ‘select’ expression treats it as a nested element. Similarly, in data portion 294, the ‘contains’ expression treats here the ‘.name’ as a string, but the ‘select’ expression treats it as a nested element. It should be noted that data portions 291-294 are syntactically correct, and a JQ parser will not be able to identify them as invalid (at the time of design). As a result, at runtime, the filters of data portions 291-294 may raise exceptions causing messages to be not sent to the subscription systems 220.

In domains like healthcare, the action of missing messages (due to Runtime Exception) could be hazardous, potentially resulting in human life loss due to missed critical alerts, such as abnormal patient vital signs not being delivered to the attending doctors. Similarly, in financial trading, a wrong predicate could cause substantial business loss by missing high-value trades or financial opportunities. Moreover, a pub-sub system that incorrectly filters or blocks events may suffer reputational damage, face penalties, and legal actions, especially when dealing with life-critical or high-value events. Service providers that manage these types of pub-sub systems could be imposed with severe penalties in court, further intensifying the need for robust filter validation mechanisms.

Accordingly, it may be desirable that predicate-based filters be validated (checked for syntactic and semantic accuracy) at the design phase, that is, when a subscriber sends (to pub-sub system 200) a new subscription request (assumed to be 225-3 received from subscriber system 220-3), prior to being added to pub-sub system 200.

Referring again to FIG. 2A, validation tool 250, provided according to several aspects of the present disclosure, validates predicate-based filters used in asynchronous messaging systems (such as pub-sub system 200). Though shown as a part of pub-sub system 200, in alternative embodiments, validation tool 250 may be implemented as a separate component executing on one of nodes 135/165/175, as will be apparent to one skilled in the relevant arts by reading the disclosure herein. The manner in which validation tool 250 validates predicate-based filters used in asynchronous messaging systems is described below with examples.

### 5. Validating Predicate-Based Filters

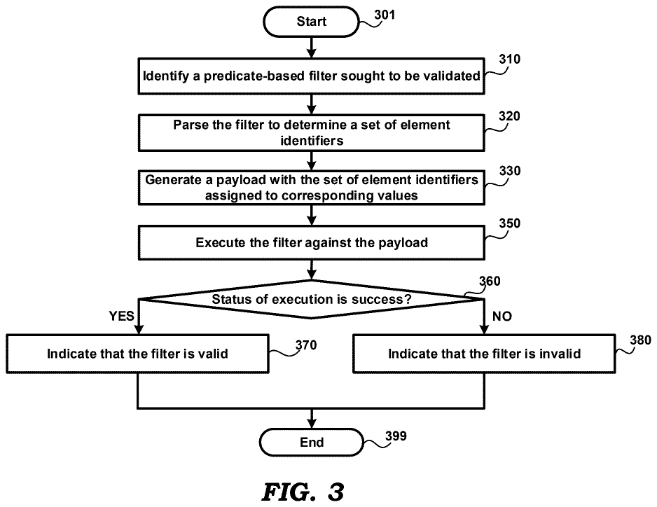

FIG. 3 is a flow chart illustrating the manner in which predicate-based filters used in asynchronous messaging systems are validated according to aspects of the present disclosure. The flowchart is described with respect to the systems of FIGS. 1 and 2, in particular validation tool 250, merely for illustration. However, many of the features can be implemented in other environments also without departing from the scope and spirit of several aspects of the present invention, as will be apparent to one skilled in the relevant arts by reading the disclosure provided herein.

In addition, some of the steps may be performed in a different sequence than that depicted below, as suited to the specific environment, as will be apparent to one skilled in the relevant arts. Many of such implementations are contemplated to be covered by several aspects of the present invention. The flow chart begins in step 301, in which control immediately passes to step 310.

In step 310, validation tool 250 identifies a predicate-based filter sought to be validated. For example, upon receiving, at a pub-sub system (200), a subscription request containing the predicate-based filter, the subscription request may be forwarded to validation tool 250, which in turn may extract the predicate-based filter from the subscription request.

In step 320, validation tool 250 parses the predicate-based filter to determine a set of element identifiers (specified in the filter). As noted above, the set of element identifiers may be a subset of the identifiers specified in the message schema. Any text-based parsing technique may be used for determining the element identifiers.

According to an aspect, validation tool 250 provides to a parser generator, a grammar and the predicate-based filter as inputs and obtains a filter tree as output, the filter tree representing an abstract syntax tree corresponding to the predicate-based filter. Validation tool 250 then uses the filter tree to determine the set of element identifiers.

In step 330, validation tool 250 generates a payload with the set of element identifiers assigned to corresponding values. The payload may be generated similar to data portion 271 and 272, but containing only the element identifiers specified in the predicate-based filter. It should be noted that the values can be generated at random, with no significance attached to their magnitude (e.g., small vs large, negative vs positive, etc.). The only significance attached to the generated value is their data type.

In step 350, validation tool 250 executes the predicate-based filter against the generated payload. Such execution may be performed similar to filter evaluator 240 and may entail applying the predicate-based filter against the payload generated in step 330.

In step 360, validation tool 250 checks whether a status of execution (of the filter against the payload) equals success. According to an aspect, validation tool 250 determines whether executing (predicate-based filter against the payload) of the payload causes a fault (error/exception) and sets the status to success if validation tool 250 determines that no the fault is caused by executing.

According to another aspect, when the executing causes the fault, validation tool 250 checks whether the fault is a recoverable fault or a non-recoverable fault. If the fault is recoverable fault, the system forms a new payload with at least one element identifier of the set of element identifiers assigned to a new value and performs the executing (step 250), the determining and the setting for the predicate-based filter against the new payload. If the fault is non-recoverable fault, the system sets the status to a failure. Control passes to step 370 if the status of execution equals success, or to step 380 otherwise.

In step 370, validation tool 250 indicates that the predicate-based filter is valid. In the scenario that the filter was part of a subscription request, a new subscription is created in the pub-sub system (200) based on the subscription request. Control passes to step 399, where the flowchart ends.

In step 380, validation tool 250 indicates that the predicate-based filter is invalid. In the scenario that the filter was part of a subscription request, the pub-sub system (200) rejects the subscription request. Control passes to step 399, where the flowchart ends.

Thus, validation tool 250 validates predicate-based filters used in asynchronous messaging systems (pub-sub system 200). It may be appreciated that such validation ensures that predicate-based filters defined by subscribers are validated before execution to prevent incorrect filtering and event loss. Also, the filters are rigorously tested using dynamically generated payloads, simulating real-world event data. Such testing mitigates risks resulting from incorrect filters such as failure to notify doctors about urgent test results or critical patient updates, with potentially life-threatening consequences. The manner in which validation tool 250 may be implemented to provide several aspects of the present disclosure according to the steps of FIG. 3 is described below with examples.

### 6. Validation Tool

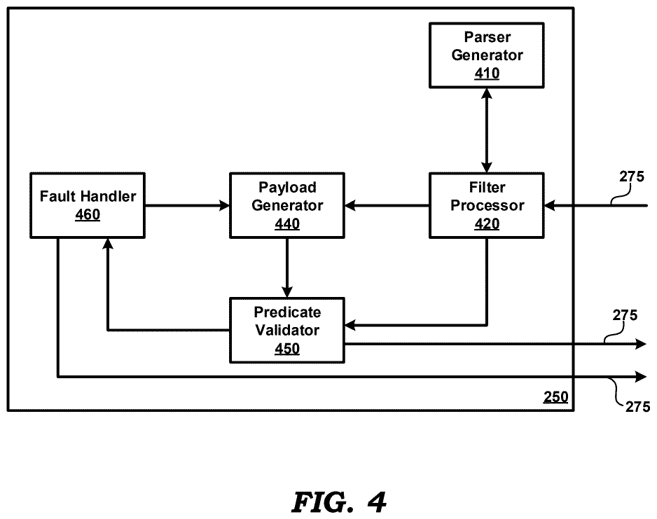

FIG. 4 is a block diagram illustrating an implementation of a validation tool (150) in one embodiment. The block diagram is shown containing parser generator 410, filter processor 420, payload generator 440, predicate validator 450 and fault handler 460. Each block of the Figure is described below in further detail.

Parser generator 410 is designed to read a grammar and generate a recognizer for the language defined by the grammar (i.e., a program that reads an input stream and generates an error if the input stream does not conform to the syntax specified by the grammar). When both the grammar and the input stream are provided, parser generator 410 parses the input stream as per the grammar, and if there are no syntax errors, generates an abstract syntax tree capturing the structure of the input stream. An example of such a parser generator is ANTLR (ANother Tool for Language Recognition). In the context of pub-sub systems, ANTLR can be used to parse filter expressions written by subscribers, validate the syntax of these expressions, and ensure that the expressions can be correctly evaluated against incoming messages.

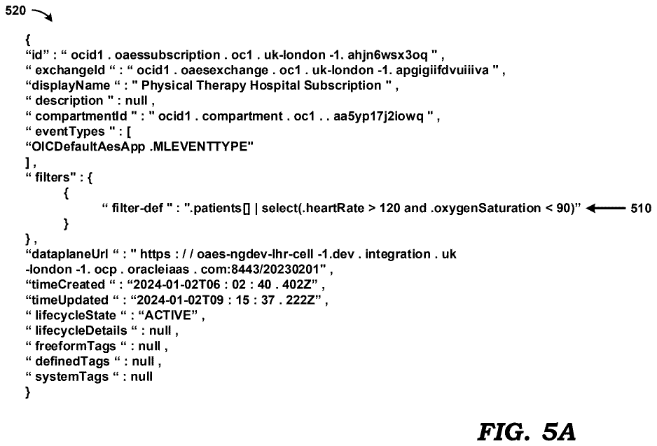

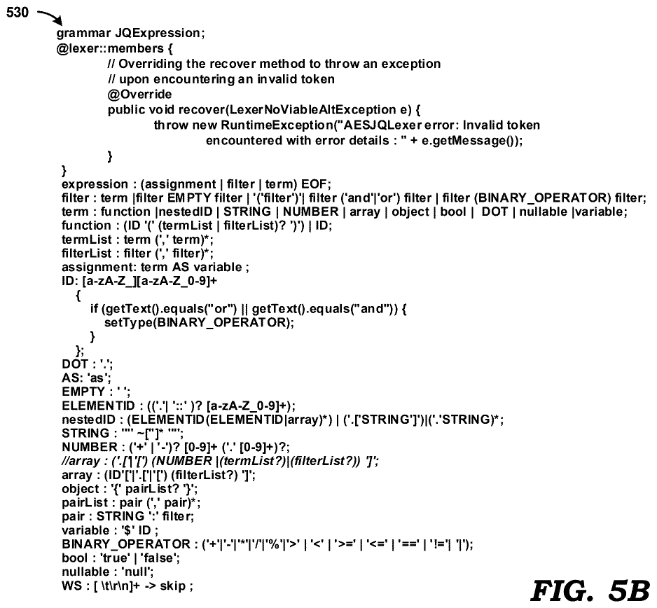

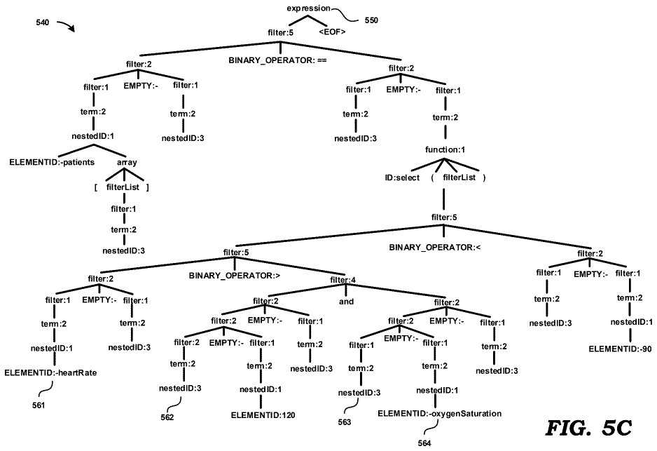

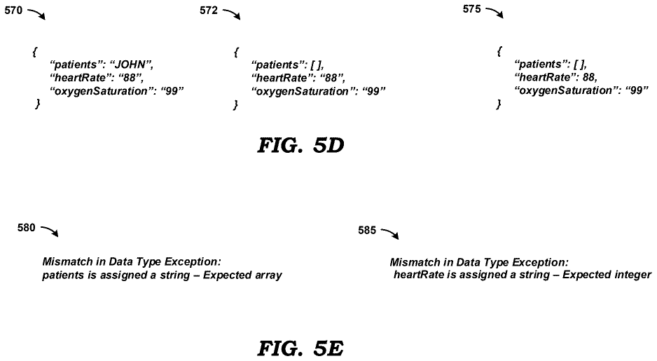

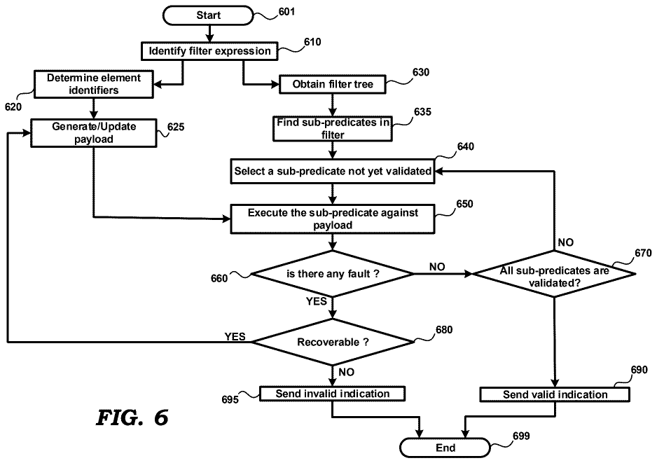

Filter processor 420 receives (via path 245) a subscription request forwarded by subscription manager 260, and extracts the predicate-based filter contained in the forwarded subscription request. FIG. 5A depicts portions of a subscription request received by a pub-sub system (200) in one embodiment. The request is shown received according to JSON format. Filter processor 420 receives data portion 520, and then extracts the data specified for the keyword “filters”, that is data portion 510 as the predicate-based filter contained in the request. Filter processor 420 first forwards the extracted predicate-based filter to predicate validator 450.

Filter processor 420 then provides to parser generator 430, a grammar and the predicate-based filter as inputs. FIG. 5B depicts portions of a grammar that can be used for parsing predicated-based filters in one embodiment. Specifically, data portion 530 specifies the grammar for JQ filter expressions involving logical and BINARY operators with comparisons and also supporting nested elements. For illustration, the grammar of data portion 530 defines the rules for parsing filter expressions involving logical AND/OR operators, parentheses for grouping, and comparisons between fields and values. Similarly, a more complete grammar may be defined for all JQ filter expressions, as will be apparent to one skilled in the relevant arts.

Filter processor 420 provides data portions 510 and 530 as inputs to parser generator 410, and obtains a filter tree as output, the filter tree representing an abstract syntax tree corresponding to the predicate-based filter. FIG. 5C depicts portions of a filter tree generated corresponding to a predicate-based filter in one embodiment. Specifically, filter tree 540 represents the filter tree generated corresponding to the predicate-base filter of data portion 510.

It may be observed that filter tree 540 contains multiple nodes including a root node (550) and terminal nodes (561, 562, etc.) that represent either element identifiers or values. The intermediate nodes between the root node and the terminal nodes represent binary operators. Filter processor 420 then uses filter tree 540 to determine the terminal nodes starting with an alphabet as the set of element identifiers {“patients”, “heartRate”, “oxygenSaturation”} and forwards the determined element identifiers to payload generator 440.

Payload generator 440 receives the set of element identifiers determined from the predicate-based filter and generates a payload with each of the set of element identifiers assigned to a corresponding value. In one embodiment, the assigned value is selected from a predefined dummy dataset. FIG. 5D depicts sample payloads that are dynamically generated for validating a predicate-based filter in one embodiment. Specifically, data portion 570 depicts a payload generated corresponding to element identifiers determined from the predicate-based filter shown in data portion 510. Each of the element identifiers {“patients” “heartRate”, “oxygenSaturation”} is shown assigned a corresponding value. Payload generator 440 forwards the generated payload to predicate validator 450.

Predicate validator 450 receives a predicate-based filter (here, data portion 510) sought to be validated from filter processor 420 and the generated payload (data portion 570) from payload generator 450 and then executes the received filter against the generated payload. Predicate validator 450, operating similarly to filter evaluator 240, applies received filter F (510) against the generated payload M (570) to determine whether the execution is a success or causes a fault (exception). If no fault is caused, predicate validator 450 sets the status of execution as success and sends (via path 275) an indication that the predicate-based filter is valid. On the other hand, if execution of the filter causes a fault, predicate validator 450 forwards the fault to fault handler 460.

Fault handler 460 receives (from predicate validator 450) the fault and checks whether the fault is a recoverable fault or a non-recoverable fault. A recoverable fault is typically a fault due to a data type mismatch. These data types could be either String, Numeric, Integer, Array, and Object type. A non-recoverable fault typically is an actual syntax error in the filter, which is identified and will be raised as a fault. In the scenario that the fault is a non-recoverable fault, fault handler 460 sets the status of execution as failure and sends (via path 275) an indication that the predicate-based filter is invalid.

However, if the fault is a recoverable fault, fault handler 460 analyzes a text of the recoverable fault to determine that the data type mismatch and then forward the details of the mismatch to payload generator 440. FIG. 5E depicts the texts of recoverable faults caused during execution of a predicate-based validator against dynamically generated payloads in one embodiment. Specifically, data portion 580 depicts the text of a Mismatch in Datatype Exception caused during execution of the predicate-based filter shown in data portion 510 against the payload of data portion 570. It may be observed that the fault is caused due to the value assigned to “patients” element identifier being of data type String, while the expected data type is Array (in view of the “[]” being present in the filter). Fault handler 460 accordingly forwards to payload generator 440 an update indication that the “patients” element identifier is to be assigned a value of Array data type.

Payload generator 440, in response to the update indication, forms a new payload by updating the specific element identifier (“patients”) in the (older) payload to a new value of the determined data type (Array). Data portion 572 depicts an updated payload generated corresponding to element identifiers determined from the predicate-based filter shown in data portion 510. It may be observed that now the element identifier “patients” is assigned an Array value of [] (empty array). Payload generator 440 forwards the updated payload to predicate validator 450.

Predicate validator 450 then performs the execution of the predicate-based filter (of data portion 510) against the updated payload and performs the operations noted above. It may be appreciated that the execution of the filter of data portion 510 against the dynamically generated payload of data portion 572 also causes a recoverable fault, specifically, a Mismatch in Datatype Exception shown in data portion 585. The text in data portion 585 indicates that the fault is caused due to the value assigned to “heartRate” element identifier being of data type String, while the expected data type is Integer according to the schema of data portion 270. As such, fault handler 460 forwards to payload generator 440 an update indication that the “heartRate” element identifier is to be assigned a value of Integer data type, with the payload generator 440 updating the element identifier to an integer value as shown in data portion 575. The updated payload of data portion 575 is then sent to predicate validator 450, which in turn executes the filter of data portion 510 against the update payload of data portion 575.

It may be appreciated that the loop of payload generator 440, predicate validator 450 and fault handler 460 may be performed multiple times (due to a sequence of recoverable faults) until the status of execution of predicate-based filter is set to success or failure (and correspondingly indicated to be either valid or invalid to subscription manager 260). According to an aspect, upon receiving an indication that a predicate-based filter specified in a subscription request is valid, subscription manager 260 creates (by adding to data store 265) a new subscription based on the subscription request (here, 225-3). Alternatively, if the indication indicates that the filter is invalid, subscription manager 260 rejects the subscription request 225-3.

Thus, validation tool 250 is implemented to validate predicate-based filters used in asynchronous messaging systems (pub-sub system 200). According to an aspect, validation tool 250 is also designed to find a set of sub-predicates contained in the predicate-based filter, and perform executing and determining for each sub-predicate against the payload. The manner in which the various components of validation tool 250 performs validation of sub-predicates is described below with examples.

### 7. Validating Sub-Predicates

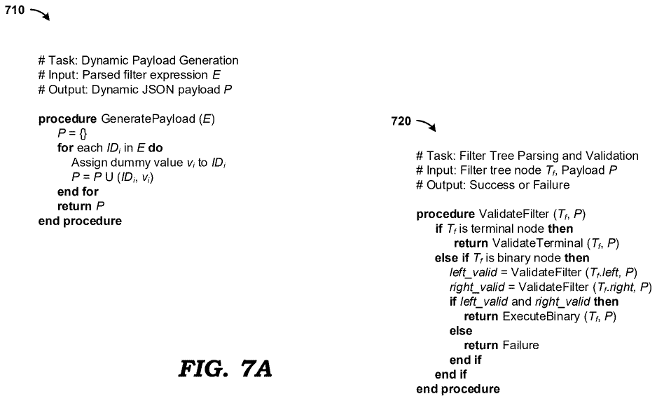

FIG. 6 is a flow chart illustrating the manner in which sub-predicates of a predicate-based filter are validated according to aspects of the present disclosure. The flowchart is described with respect to the system of FIG. 4 merely for illustration. However, many of the features can be implemented in other environments also without departing from the scope and spirit of several aspects of the present invention, as will be apparent to one skilled in the relevant arts by reading the disclosure provided herein.

In addition, some of the steps may be performed in a different sequence than that depicted below, as suited to the specific environment, as will be apparent to one skilled in the relevant arts. Many of such implementations are contemplated to be covered by several aspects of the present invention. The flow chart begins in step 601, in which control immediately passes to step 610.

In step 610, filter processor 420 Identifies filter expression such as a predicate-based filter contained in a subscription request.

In step 620, filter processor 420 determines element identifiers using a parser generator (410) and a grammar shown in data portion 530.

In step 625, payload generator 440 generates a payload based on the determined element identifiers.

In step 630, filter processor 420 obtains filter tree corresponding to the filter expression using parser generator 410 and grammar of data portion 530.

In step 635, predicate validator 450 finds sub-predicates in filter expression. Specifically, the filter expression is split into multiple parts based on the “and” and “or” operators specified in the expression, with each part forming a sub-predicate. As such, the predicate-based filter of data portion 510 is found to have two sub-predicates “heartRate >120” and “oxygenSaturation <90”.

In step 640, predicate validator 450 selects a sub-predicate not yet validated.

In step 650, predicate validator 450 executes the selected sub-predicate against payload (generated in step 625).

In step 660, predicate validator 450 checks whether there is there any fault. Control passes to step 680 if any fault is there and to step 670 otherwise.

In step 670, predicate validator 450 checks whether all sub-predicates are validated. Control passes to step 690 if all sub-predicates have been validated and to step 640 otherwise (whereby another sub-predicate not yet validated is selected and processed).

In step 690, predicate validator 450 sends a valid indication indicating that the filter expression is valid. Control passes to step 699, where the flowchart ends.

In step 680, fault handler 460 checks whether the fault is recoverable. Control passes to step 625 (whereby the payload is updated and send to predicate validator 450), and to step 695 otherwise.

In step 695, fault handler 460 sends an invalid indication indicating that the filter expression is invalid. Control passes to step 699, where the flowchart ends.

Thus, components of validation tool 250 handle the validation of sub-predicates of a predicate-based filter. It may be appreciated that validation tool 250 indicates that the filter is valid (sets the status of execution to success) if no fault is caused by the executing of all of the set of sub-predicates, and indicates that the filter in invalid (sets the status of execution to failure) if a non-recoverable fault is caused by the executing of any of the set of sub-predicates. By recursively breaking down complex predicates into atomic expressions, the system validates each filter component against real or synthetic data, ensuring that the filter behaves as expected.

According to an aspect, the steps of FIG. 6 is implemented as an evaluation (traversal) of a filter tree obtained corresponding to the predicate-based filter. Such an implementation based on filter tree traversal is described below with examples.

### 8. Example Implementation

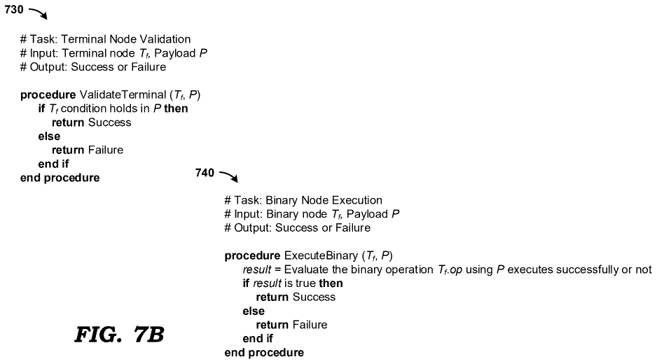

FIGS. 7A-7B together depicts a set of procedures used to validate a predicate-based filter in one embodiment. The procedures are shown coded in pseudocode for illustration, though in alternative embodiments, the procedures may be coded in any programming language as will be apparent to one skilled in the relevant arts by reading the disclosure herein. Each of the procedures is described in detail below.

Referring to FIG. 7A, data portion 710 depicts a procedure named “GeneratePayload” for generating a payload based on a parsed filter expression E provided as input. The procedure generates a payload, it iteratively traverses the filter tree (540) corresponding to the filter expression E (510) and figures out all the nested elements and assigns a dummy value against the elements. So, for the data portion 510, the following are performed:
1. Initialize P as {}
2. Discard all the other values and select elements iteratively {“patients”, “heartrate”, “oxygenSaturation”}
3. For each element Eᵢ and for IDᵢⱼ in Eᵢ, add IDᵢⱼ (Id because element Eᵢ could have nested ids) to P with a dummy value.

During execution, the payload P will be {“patients”, “JOHN”} after first iteration, {“patients”, “JOHN”, “heartRate”: “88”} after second iteration and will be {“patients”, “JOHN”, “heartRate”: “80”, “oxygenSaturation”: “99”} and after the third iteration. The payload P output by GeneratePayload is shown in data portion 570. It may be appreciated that the “patients” element identifier is assigned a String data type, though the expected is a Array type. The discrepancy will be identified later while executing the generated payload through validation as described in detail below.

Data portion 720 depicts a procedure named “ValidateFilter” for validating a filter that takes as inputs a filter tree (such as that shown in 540) corresponding to the same filter expression E and a given payload P, that may be generated as an output of invoking the procedure. As such, for validating a filter expression E, procedure 710 is invoked first to obtain P as the output, and then procedure 720 is invoked with the root node of the filter tree T_{f} and payload P.

Recursively, procedure ValidateFilter starts breaking down the filter as sub binary filter till it gets to terminal node. So for given tree (data portion 540) first it breaks down the tree into sub binary nodes (Ignoring Empy Nodes): {“heartRate”==“88”}, {“oxygenSaturation”=“99”} and terminal node {patients []}. Further, the sub binary nodes get break down in the terminal node (Ignoring Empty Nodes): {“heartRate”}, {“88”}, {“oxygenSaturation”}, and {“99”}. The procedure calls ValidateTerminal (T_{f}, P) for each terminal node and checks whether each node is legitimate and not resulting in an error.
RecursiveCallSet-1: Hence for the example given above sole terminal execution {patients []} will take place first. As part of this execution, the ValidateFilter ({patients[]}, P) will get called, and at subsequent step ValidateTerminal ({patients[]}, P) get the call, and with generated payload, it will get a RecoveryFault which is subsequently handled by the fault handler and as a result will generate a second payload as shown in data portion 572. It should be noted that there is a further tuning of payload done by the system for an array type, just before its ExecuteBinary, as further described with respect to RecusiveCallSet-6.
RecursiveCallSet-2: So for the above example for sub binary tree {“heartRate”=“88”}, the procedure breaks down it into two terminal nodes {“heartRate”}, {“88”} which gets executed by:
   left_valid=ValidateFilter ({T_{f}.left “heartRate”}, P) which further calls ValidateTerminal ({T_{f}.left “heartRate”}, P) as this is a terminal node;
   right_valid=ValidateFilter (T_{f}.right “88”, P) which further calls ValidateTerminal ({T_{f}.right “88”}, P) as this is a terminal node; and
   if left and right results are valid, the procedure calls ExecuteBinary (T_{f} {“heartRate”==“88”}, P).
RecursiveCallSet-3: Similarly as part of another recursive call for the above example for sub binary tree {“oxygenSaturation”=“99”}, the procedure breaks down the tree into two terminal nodes {“oxygenSaturation”}, {“99”} which gets executed by:
   left_valid=ValidateFilter ({T_{f}.left “oxygenSaturation”}, P) which further calls ValidateTerminal ({T_{f}.left “oxygenSaturation”}, P) as this is a terminal node;
   right_valid=ValidateFilter (T_{f}.right “99”, P) which further calls validateTerminal({T_{f}.right “99”}, P) as this is a terminal node; and
   if left and right results are valid, the procedure calls ExecuteBinary (T_{f} {“oxygenSaturation”==“99”}, P).
RecursiveCallSet-4: Once valid results from RecursiveCallSet-2 and RecursiveCallSet-3, that is, left_valid=RecursiveCallSet-2, right_valid=RecursiveCallSet-3, then the procedure call upper layer binary statement as part of RecusiveCallSet-4: ExecuteBinary (T_{f} {“heartRate”==“88”} and {“oxygenSaturation”==“99”}, P)
RecursiveCallSet-5: As part of the next step RecursiveCallSet-5, the procedure call upper layer terminal statement validateTerminal (T_{f} {select({“heartRate”=“88”} and {“oxygenSaturation”==“99”})}) is performed.
RecursiveCallSet-6: Just before this execution, the system checks if there exists an array data type an if so, the system includes payload generated by the right child elements of the tree. Hence payload will be: {“patients”:[{“heartRate”: “80”, “oxygenSaturation”: “99”}]} Once valid results from RecursiveCallSet-1 and RecursiveCallSet-5, that is, left_valid=RecursiveCallSet-1, right_valid=RecursiveCallSet-5, then the procedure call upper layer binary statement as part of RecusiveCallSet-6: ExecuteBinary (T_{f} patients[] |select({“heartRate”=“88”} and {“oxygenSaturation”==“99”}), P).

Thus, in procedure 720, it is checked whether the current node (pointed to by T_{f}) is a terminal node or a binary node. If a terminal node, the procedure validate terminal in data portion 730 is invoked and the status returned by the procedure is returned as the output of procedure 720. When the node is a binary node, procedure 720 is invoked with the left branch of the current node, effectively evaluating the left subtree of the current node against the payload to return a left result. Procedure 720 is then invoked with the right branch of the current node, effectively evaluating a right subtree of the node against the payload to return a right result. If the left result and the right result are both success, procedure execute binary is invoked and its output is returned as the output of procedure 720.

Referring to FIG. 7B, data portion 730 depicts a procedure named “ValidateTerminal” for validating a terminal node. The procedure takes as inputs the terminal node and the payload and returns a success if a condition associated with the terminal node holds against the payload or a failure otherwise. It should be noted that each terminal node may be one of a nested element, a value and a function. In the scenario that the terminal node is a nested element, the procedure evaluates the element as part of JQ Expression or XPath if the nested element exists; if the evaluation is successful, the terminal node is marked as success. For example, for the terminal node “heartRate”′ that will always exist in the payload generated, the procedure returns “Success”.

When the terminal node is a value (string/number), the terminal node is just ignored and are marked as success. When the terminal node is a function, the function is evaluated, and the result is set to success if the result of evaluation is a success. Otherwise, if a recoverable fault is got, the procedure tries to recover, else raise the issue. Example: For function contains (“dummy”), the procedure just checks if this executes well or not, if it executes well the procedure sends true else check Fault type and try to recover. It should be noted, for any element which is already updated/recovered, the procedure does not touch that for the second recovery/update. For that scenario, the procedure raises an unrecoverable fault.

Data portion 740 depicts a procedure for executing a binary node. The procedure takes as inputs the binary node and the payload, and returns a success if a binary operation associated with the binary node executes successfully against the payload or a failure otherwise as noted above with respect to ValidateTerminal.

Thus, the process of filter validation using dynamically generated payloads involves parsing complex filter expressions, generating dynamic JSON payloads, and executing them against the filters. The core process is structured using recursive procedures that break down filters into atomic parts and validate them step by step.

Some of the features of the predicate-based filter validation system (250) are Dynamic Payload Generation—The system dynamically generates test payloads based on the filter subscription; Recursive Filter Parsing—The system breaks down complex filter predicates into atomic sub-expressions, recursively validating each part. For instance, a predicate like (heartrate>100 AND oxygenLevel<90) is split into two simple parts (heartRate>100) and (oxygenLevel<90), which are validated independently before the overall predicate is validated; Syntactic and Semantic Validation—The system not only checks the syntax of the predicate expressions (to ensure they are valid according to the predicate language (e.g., XPath, JQ, SQL-like predicates) but also performs semantic checks by executing the filters against generated payloads to confirm they yield the correct results; User-Friendly Feedback—In case of invalid filters, the system may provide descriptive error messages indicating where the predicate failed and suggesting potential corrections. This is crucial for non-technical users like doctors or lab assistants; and Real-Time Execution and Correction—Once the filter expressions are corrected, the system allows real-time testing, ensuring that valid events pass through while invalid ones are rejected, without impacting live operations.

It may be appreciated that such a predicate-based filter validation system provides error prevention, i.e., by validating predicates during the subscription process, the system ensures that no incorrect or invalid filters are applied, preventing false negatives (missed legitimate events), which leads to improved subscriber confidence. Accordingly, the features can be useful in a broad array of areas such as healthcare context noted above, trading, legal and compliance, etc.

It should be further appreciated that the features described above can be implemented in various embodiments as a desired combination of one or more of hardware, software, and firmware. The description is continued with respect to an embodiment in which various features are operative when the software instructions described above are executed.

### 9. Digital Processing System

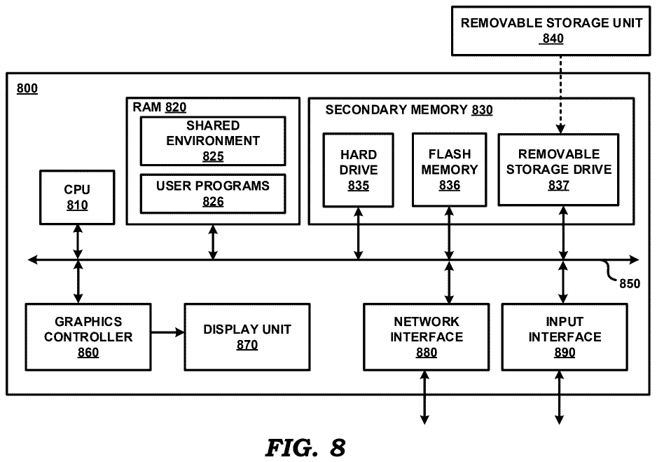

FIG. 8 is a block diagram illustrating the details of digital processing system (1000) in which various aspects of the present disclosure are operative by execution of appropriate executable modules. Digital processing system 800 may correspond to validation tool 250.

Digital processing system 800 may contain one or more processors such as a central processing unit (CPU) 810, random access memory (RAM) 820, secondary memory 830, graphics controller 860, display unit 870, network interface 880, and input interface 890. All the components except display unit 870 may communicate with each other over communication path 850, which may contain several buses as is well known in the relevant arts. The components of FIG. 8 are described below in further detail.

CPU 810 may execute instructions stored in RAM 820 to provide several features of the present disclosure. CPU 810 may contain multiple processing units, with each processing unit potentially being designed for a specific task. Alternatively, CPU 810 may contain only a single general-purpose processing unit.

RAM 820 may receive instructions from secondary memory 830 using communication path 850. RAM 820 is shown currently containing software instructions constituting shared environment 825 and/or other user programs 826 (such as other applications, DBMS, etc.). In addition to shared environment 825, RAM 820 may contain other software programs such as device drivers, virtual machines, etc., which provide a (common) run time environment for execution of other/user programs.

Graphics controller 860 generates display signals (e.g., in RGB format) to display unit 870 based on data/instructions received from CPU 810. Display unit 870 contains a display screen to display the images defined by the display signals. Input interface 890 may correspond to a keyboard and a pointing device (e.g., touch-pad, mouse) and may be used to provide inputs. Network interface 880 provides connectivity to a network (e.g., using Internet Protocol), and may be used to communicate with other systems connected to the networks.

Secondary memory 830 may contain hard drive 835, flash memory 836, and removable storage drive 837. Secondary memory 830 may store the data (e.g., data shown in FIGS. 2A-2D and 5A-5E) and software instructions (e.g., for performing the actions of FIGS. 3 and 6, for implementing the blocks of FIGS. 2 and 4, corresponding to the pseudocode of FIGS. 7A-7B), which enable digital processing system 800 to provide several features in accordance with the present disclosure. The code/instructions stored in secondary memory 830 may either be copied to RAM 820 prior to execution by CPU 810 for higher execution speeds, or may be directly executed by CPU 810.

Some or all of the data and instructions may be provided on removable storage unit 840, and the data and instructions may be read and provided by removable storage drive 837 to CPU 810. Removable storage unit 840 may be implemented using medium and storage format compatible with removable storage drive 837 such that removable storage drive 837 can read the data and instructions. Thus, removable storage unit 840 includes a computer readable (storage) medium having stored therein computer software and/or data. However, the computer (or machine, in general) readable medium can be in other forms (e.g., non-removable, random access, etc.).

In this document, the term “computer program product” is used to generally refer to removable storage unit 840 or hard disk installed in hard drive 835. These computer program products are means for providing software to digital processing system 800. CPU 810 may retrieve the software instructions, and execute the instructions to provide various features of the present disclosure described above.

The term “storage media/medium” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage memory 830. Volatile media includes dynamic memory, such as RAM 820. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 850. Transmission media can also take the form of acoustic or light waves, such as those generated during radio-wave and infra-red data communications.

Reference throughout this specification to “one embodiment”, “an embodiment”, or similar language means that a particular feature, structure, or characteristic described in connection with the embodiment is included in at least one embodiment of the present disclosure. Thus, appearances of the phrases “in one embodiment”, “in an embodiment” and similar language throughout this specification may, but do not necessarily, all refer to the same embodiment.

Furthermore, the described features, structures, or characteristics of the disclosure may be combined in any suitable manner in one or more embodiments. In the above description, numerous specific details are provided such as examples of programming, software modules, user selections, network transactions, database queries, database structures, hardware modules, hardware circuits, hardware chips, etc., to provide a thorough understanding of embodiments of the disclosure.

It should be understood that the figures and/or screen shots illustrated in the attachments highlighting the functionality and advantages of the present disclosure are presented for example purposes only. The present disclosure is sufficiently flexible and configurable, such that it may be utilized in ways other than that shown in the accompanying FIG.

### 10. Conclusion

While various embodiments of the present disclosure have been described above, it should be understood that they have been presented by way of example only, and not limitation. Thus, the breadth and scope of the present disclosure should not be limited by any of the above-described exemplary embodiments, but should be defined only in accordance with the following claims and their equivalents.

It should be understood that the figures and/or screen shots illustrated in the attachments highlighting the functionality and advantages of the present disclosure are presented for example purposes only. The present disclosure is sufficiently flexible and configurable, such that it may be utilized in ways other than that shown in the accompanying figures.

Further, the purpose of the following Abstract is to enable the Patent Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present disclosure in any way.

What is claimed is:

1. A method for validating predicate-based filters, the method comprising:
identifying a predicate-based filter sought to be validated;
parsing said predicate-based filter to determine a set of element identifiers contained in said predicate-based filter;
generating a payload with each of said set of element identifiers assigned to a corresponding value;
executing said predicate-based filter against said payload; and
indicating that said predicate-based filter is valid if a status of said executing is a success, and is invalid otherwise.

2. The method of claim 1, further comprising:
receiving, at a pub-sub system, a subscription request containing said predicate-based filter, wherein said identifying comprises extracting said predicate-based filter from said subscription request; and
creating, in said pub-sub system, a new subscription based on said subscription request if said indicating indicates that said predicate-based filter is valid and rejecting said subscription request if said indicating indicates that said predicate-based filter is invalid.

3. The method of claim 1, further comprising:
determining whether said executing causes a fault; and
setting said status to said success if said determining determines that no said fault is caused by said executing.

4. The method of claim 3, wherein said fault is a Run time Exception, wherein when said executing causes said fault, said method further comprises:
checking whether said fault is a recoverable fault or a non-recoverable fault;
if said fault is said recoverable fault:
forming a new payload with at least one element identifier of said set of element identifiers assigned to a new value; and
performing said executing, said determining and said setting for said predicate-based filter against said new payload; and
if said fault is said non-recoverable fault:
setting said status to a failure.

5. The method of claim 4, wherein said recoverable fault is a mismatch in data type for a first element identifier in said set of element identifiers, wherein said forming comprises:
analyzing a text of said recoverable fault to determine that said first element identifier is of a first data type; and
updating said first element identifier in said payload to said new value of said first data type to form said new payload.

6. The method of claim 4, further comprising finding a set of sub-predicates contained in said predicate-based filter,
wherein said executing and said determining are performed for each sub-predicate of said set of sub-predicates against said payload,
wherein said setting sets said status to said success if said determining determines that no said fault is caused by said executing of all of said set of sub-predicates,
wherein said setting sets said status to said failure if said non-recoverable fault is caused by said executing of any of said set of sub-predicates.

7. The method of claim 6, wherein said parsing comprises:
providing to a parser generator, a grammar and said predicate-based filter as inputs and obtaining a filter tree as output, said filter tree representing an abstract syntax tree corresponding to said predicate-based filter; and
using said filter tree to determine said set of element identifiers and find said set of sub-predicates.

8. The method of claim 7, wherein said filter tree contains a plurality of nodes including a root node and terminal nodes, wherein said executing comprises evaluating said filter tree starting from said root node, wherein said evaluating a node comprises:
if said node is a binary node:
evaluating a left subtree of said node against said payload to return a left result;
evaluating a right subtree of said node against said payload to return a right result; and
if said left result and said right result are both success, returning a success if a binary operation associated with said node executes successfully against said payload or a failure otherwise; and
if said node is a terminal node:
returning a success if a condition associated with said node holds against said payload or a failure otherwise.

9. A non-transitory machine-readable medium storing one or more sequences of instructions for validating predicate-based filters, wherein execution of said one or more instructions by one or more processors contained in a digital processing system cause said digital processing system to perform the actions of:
identifying a predicate-based filter sought to be validated;
parsing said predicate-based filter to determine a set of element identifiers contained in said predicate-based filter;
generating a payload with each of said set of element identifiers assigned to a corresponding value;
executing said predicate-based filter against said payload; and
indicating that said predicate-based filter is valid if a status of said executing is a success, and is invalid otherwise.

10. The non-transitory machine-readable medium of claim 9, further comprising one or more instructions for:
receiving, at a pub-sub system, a subscription request containing said predicate-based filter, wherein said identifying comprises extracting said predicate-based filter from said subscription request; and
creating, in said pub-sub system, a new subscription based on said subscription request if said indicating indicates that said predicate-based filter is valid and rejecting said subscription request if said indicating indicates that said predicate-based filter is invalid.

11. The non-transitory machine-readable medium of claim 9, further comprising one or more instructions for:
determining whether said executing causes a fault; and
setting said status to said success if said determining determines that no said fault is caused by said executing.

12. The non-transitory machine-readable medium of claim 11, wherein said fault is a Run time Exception, wherein when said executing causes said fault, said method further comprises one or more instructions for:
checking whether said fault is a recoverable fault or a non-recoverable fault;
if said fault is said recoverable fault:
forming a new payload with at least one element identifier of said set of element identifiers assigned to a new value; and
performing said executing, said determining and said setting for said predicate-based filter against said new payload; and
if said fault is said non-recoverable fault:
setting said status to a failure.

13. The non-transitory machine-readable medium of claim 12, further comprising one or more instructions for finding a set of sub-predicates contained in said predicate-based filter,
wherein said executing and said determining are performed for each sub-predicate of said set of sub-predicates against said payload,
wherein said setting sets said status to said success if said determining determines that no said fault is caused by said executing of all of said set of sub-predicates,
wherein said setting sets said status to said failure if said non-recoverable fault is caused by said executing of any of said set of sub-predicates.

14. The non-transitory machine-readable medium of claim 13, wherein said parsing comprises:
providing to a parser generator, a grammar and said predicate-based filter as inputs and obtaining a filter tree as output, said filter tree representing an abstract syntax tree corresponding to said predicate-based filter; and
using said filter tree to determine said set of element identifiers and find said set of sub-predicates.

15. A digital processing system comprising:
a random access memory (RAM) to store instructions for validating predicate-based filters; and
one or more processors to retrieve and execute the instructions, wherein execution of the instructions causes the digital processing system to perform the actions of:
identifying a predicate-based filter sought to be validated;
parsing said predicate-based filter to determine a set of element identifiers contained in said predicate-based filter;
generating a payload with each of said set of element identifiers assigned to a corresponding value;
executing said predicate-based filter against said payload; and
indicating that said predicate-based filter is valid if a status of said executing is a success, and is invalid otherwise.

16. The digital processing system of claim 15, further performing the actions of:
receiving, at a pub-sub system, a subscription request containing said predicate-based filter, wherein said identifying comprises extracting said predicate-based filter from said subscription request; and
creating, in said pub-sub system, a new subscription based on said subscription request if said indicating indicates that said predicate-based filter is valid and rejecting said subscription request if said indicating indicates that said predicate-based filter is invalid.

17. The digital processing system of claim 16, further performing the actions of:
determining whether said executing causes a fault; and
setting said status to said success if said determining determines that no said fault is caused by said executing.

18. The digital processing system of claim 17, wherein said fault is a Run time Exception, wherein when said executing causes said fault, said digital processing system further performing the actions of:
checking whether said fault is a recoverable fault or a non-recoverable fault;
if said fault is said recoverable fault:
forming a new payload with at least one element identifier of said set of element identifiers assigned to a new value; and
performing said executing, said determining and said setting for said predicate-based filter against said new payload; and
if said fault is said non-recoverable fault:
setting said status to a failure.

19. The digital processing system of claim 18, further performing the actions of finding a set of sub-predicates contained in said predicate-based filter,
wherein said digital processing system performs said executing and said determining for each sub-predicate of said set of sub-predicates against said payload,
wherein said digital processing system sets said status to said success if said digital processing system determines that no said fault is caused by said executing of all of said set of sub-predicates,
wherein said digital processing system sets said status to said failure if said non-recoverable fault is caused by said executing of any of said set of sub-predicates.

20. The digital processing system of claim 19, wherein for said parsing, said digital processing system performs the actions of:
providing to a parser generator, a grammar and said predicate-based filter as inputs and obtaining a filter tree as output, said filter tree representing an abstract syntax tree corresponding to said predicate-based filter; and
using said filter tree to determine said set of element identifiers and find said set of sub-predicates.
